(19) United States
(12) Patent Application Publication
(10) Pub. No.: US 2006/0201612 A1
(43) Pub. Date: Sep. 14, 2006

(54) Method for working gas permeable cushion

(76) Inventor: Meng Jie Lin, Taichung County (TW)

Correspondence Address: CHARLES E. BAXLEY, ESQ., 90 JOHN STREET, THIRD FLOOR, NEW YORK, NY, 10038, US

(21) Appl. No.: 11/077,582

(22) Filed: Mar. 10, 2005

(51) Int. Cl. B29C 65/00

(52) U.S. Cl. 156/229

(57) ABSTRACT

A method for working a gas permeable cushion includes taking a cushion body, stamping a plurality of arc-shaped sections on the cushion body, extending the cushion body to expand the arc-shaped sections, thereby forming a plurality of arc-shaped holes, and bonding two cloth layers onto the cushion body respectively, thereby forming a gas permeable cushion. Thus, the method is used for working a gas permeable cushion without needing a step of removing the wasted material, thereby simplifying the procedure of the method, so that the gas permeable cushion is worked easily and conveniently. In addition, the gas permeable cushion has a plurality of arc-shaped holes, thereby enhancing the ventilating effect of the gas permeable cushion.

### BACKGROUND OF THE INVENTION

1. Field of the Invention

The present invention relates to a method for working a gas permeable cushion, and more particularly to a method for working a gas permeable cushion without needing a step of removing the wasted material, thereby simplifying the procedure of the working method.

2. Description of the Related Art

A conventional gas permeable cushion in accordance with the prior art shown in FIGS. 14 and 15 comprises a cushion body 11 formed with a plurality of needle holes 111, and two cloth layers 12 bonded onto the top and bottom faces of the cushion body respectively. However, the cushion body 11 made of foamable material, such as EVA, PE or the like, has a resilient feature, so that the needle holes 111 are easily closed by the resilient feature of the cushion body 11, thereby decreasing the ventilating effect of the gas permeable cushion.

Another conventional gas permeable cushion in accordance with the prior art shown in FIGS. 16 and 17 comprises a cushion body 20 formed with a plurality of stamping holes 21 by a stamping process. Thus, the stamping holes 21 are not easily closed by the resilient feature of the cushion body 20. However, the cushion body 20 produces wasted material during the stamping process, so that it is necessary to remove the wasted material during the stamping process, thereby decreasing the working efficiency.

### SUMMARY OF THE INVENTION

The primary objective of the present invention is to provide a method for working a gas permeable cushion without needing a step of removing the wasted material, thereby simplifying the procedure of the method, so that the gas permeable cushion is worked easily and conveniently.

Another objective of the present invention is to provide a method for working a gas permeable cushion, wherein the gas permeable cushion has a plurality of arc-shaped holes, thereby enhancing the ventilating effect of the gas permeable cushion.

A further objective of the present invention is to provide a method for working a gas permeable cushion, wherein the arc-shaped holes are expanded and contracted according to the usage state of the user's body, thereby enhancing the ventilating effect of the gas permeable cushion.

A further objective of the present invention is to provide a method for working a gas permeable cushion, wherein the channels are located between the protruding stripes and the user's body, thereby enhancing the ventilating effect of the gas permeable cushion.

In accordance with the present invention, there is provided a method for working a gas permeable cushion, comprising:

taking a cushion body;

stamping a plurality of arc-shaped sections on the cushion body;

extending the cushion body to expand the arc-shaped sections, thereby forming a plurality of arc-shaped holes; and

bonding two cloth layers onto top and bottom faces of the cushion body respectively, thereby forming a gas permeable cushion which has a plurality of arc-shaped holes.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a method for working a gas permeable cushion in accordance with the preferred embodiment of the present invention;

FIG. 2 is a top plan view of a cushion body in accordance with the preferred embodiment of the present invention;

FIG. 3 is a top plan view showing the cushion body of FIG. 2 being stamped with a plurality of arc-shaped sections;

FIG. 4 is a top plan view showing the cushion body of FIG. 3 being extended to form a plurality of arc-shaped holes;

FIG. 5 is a perspective view showing the cushion body of FIG. 4 being bonded with two cloth layers;

FIG. 6 is a partially cut-away side plan cross-sectional view of a gas permeable cushion in accordance with the preferred embodiment of the present invention;

FIG. 7 is a schematic operational view of the gas permeable cushion as shown in FIG. 6 in use;

FIG. 8 is a plan view of the gas permeable cushion as shown in FIG. 7;

FIG. 9 is a perspective view of a gas permeable cushion in accordance with another preferred embodiment of the present invention;

FIG. 10 is a schematic operational view of the gas permeable cushion as shown in FIG. 9 in use;

FIG. 11 is a plan view of a cushion body in accordance with another preferred embodiment of the present invention;

FIG. 12 is a schematic operational view of the cushion body as shown in FIG. 11;

FIG. 13 is a schematic operational view of the cushion body as shown in FIG. 11;

FIG. 14 is a top plan view of a conventional gas permeable cushion in accordance with the prior art;

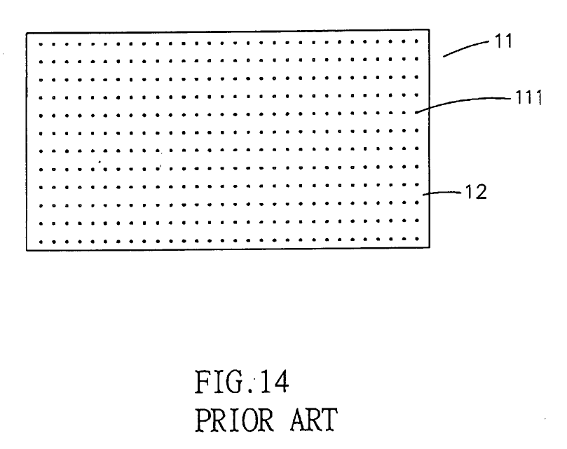

FIG. 15 is a partially cut-away side plan cross-sectional view of the conventional gas permeable cushion as shown in FIG. 14;

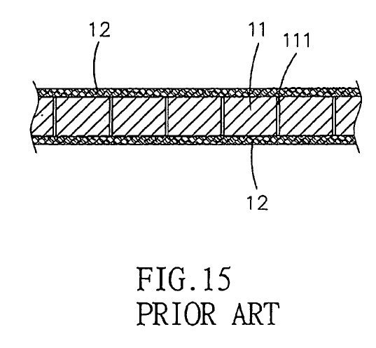

FIG. 16 is a top plan view of another conventional gas permeable cushion in accordance with the prior art; and

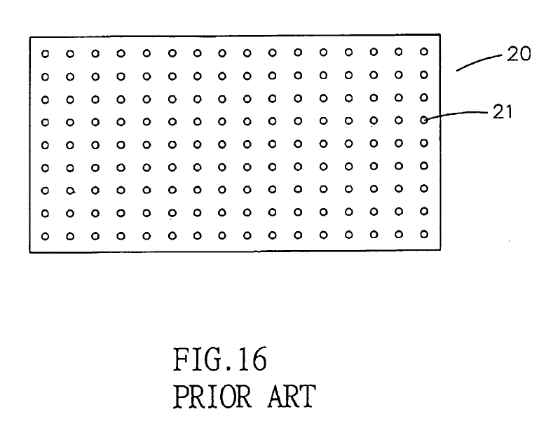

FIG. 17 is a partially cut-away side plan cross-sectional view of the conventional gas permeable cushion as shown in FIG. 16.

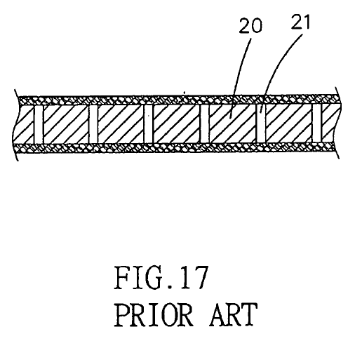

### DETAILED DESCRIPTION OF THE INVENTION

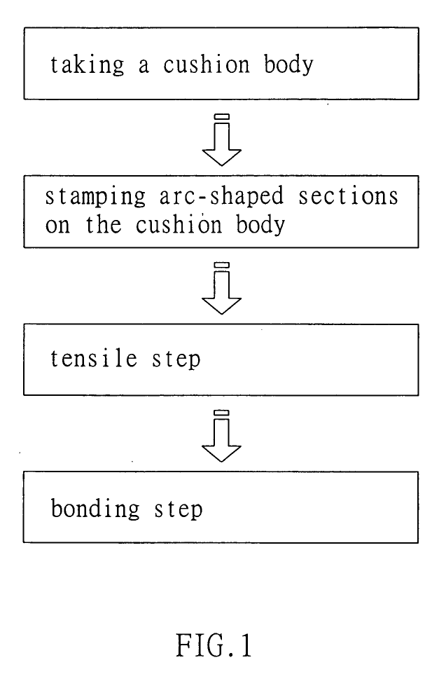

Referring to the drawings and initially to FIGS. 1-6, a method for working a gas permeable cushion in accordance with the preferred embodiment of the present invention comprises a first step of taking a cushion body 30, a second step of stamping arc-shaped sections 31, a third step of tensile action, and a four step of bonding action.

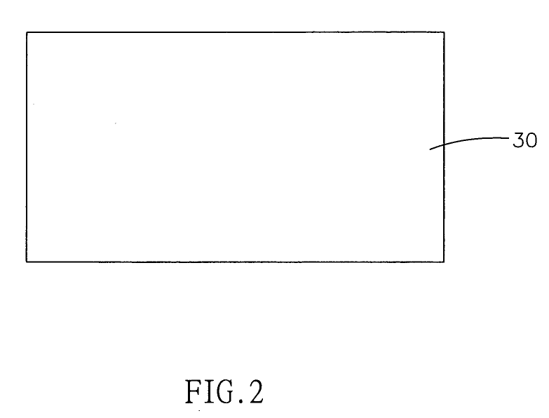

In the first step, as shown in FIG. 2, the cushion body 30 is made of flexible and foamable material. Preferably, the cushion body 30 is formed by EVA, PE, PP, SBR or PU.

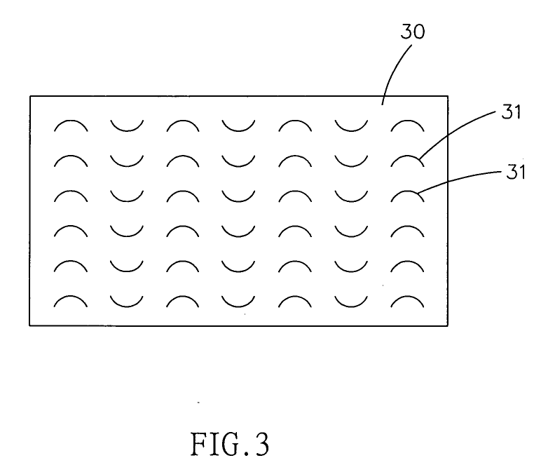

In the second step, the cushion body 30 is stamped by a die having a plurality of arc-shaped cross-section portions to form a plurality of arc-shaped sections 31 as shown in FIG. 3. In addition, the arc-shaped sections 31 have the same axial direction.

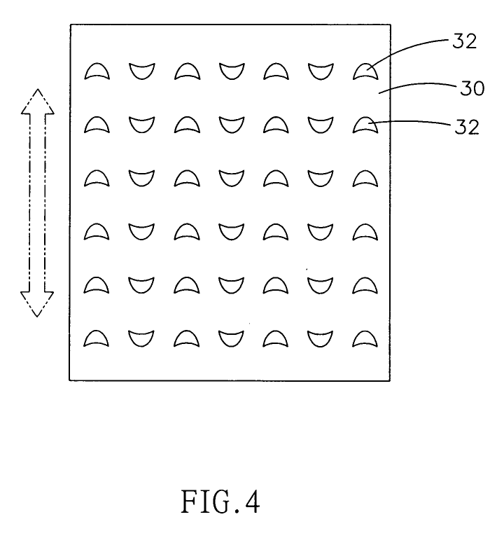

In the third step, the cushion body 30 is extended to expand the arc-shaped sections 31, thereby forming a plurality of arc-shaped holes 32 as shown in FIG. 4. In addition, the cushion body 30 is extended along the axial direction of the arc-shaped sections 31.

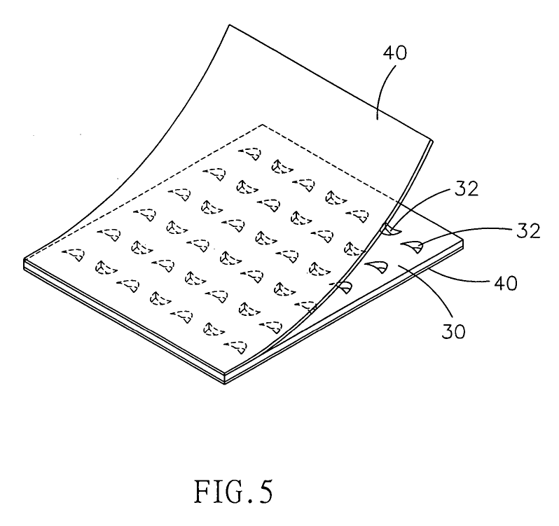

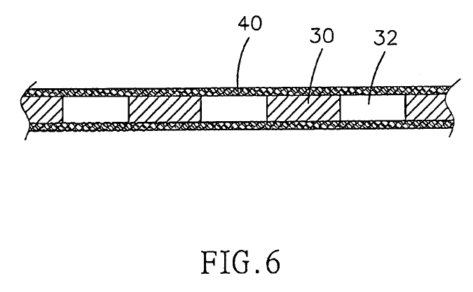

In the fourth step, two cloth layers 40 are bonded onto the top and bottom faces of the cushion body 30 respectively as shown in FIG. 5, thereby forming a gas permeable cushion as shown in FIG. 6, wherein the gas permeable cushion has a plurality of arc-shaped holes 32.

Thus, the method of the present invention is used for working a gas permeable cushion without needing a step of removing the wasted material, thereby simplifying the procedure of the method, so that the gas permeable cushion is worked easily and conveniently. In addition, the gas permeable cushion has a plurality of arc-shaped holes, thereby enhancing the ventilating effect of the gas permeable cushion.

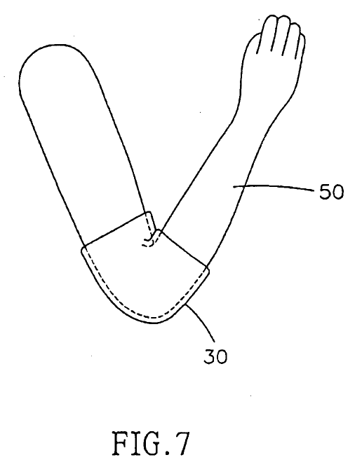

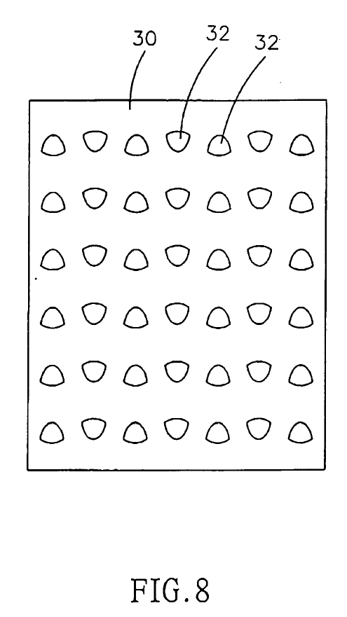

As shown in FIGS. 7 and 8, the cushion body 30 is mounted on a user's one elbow 50. In practice, the arc-shaped holes 32 are expanded when the user's one elbow 50 is bent and are contracted and restored to the original state when the user's one elbow 50 is straight. Thus, the arc-shaped holes 32 are expanded and contracted according to the usage state of the user's one elbow 50, thereby enhancing the ventilating effect of the gas permeable cushion.

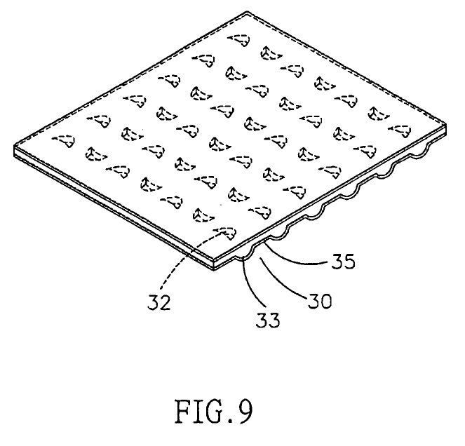

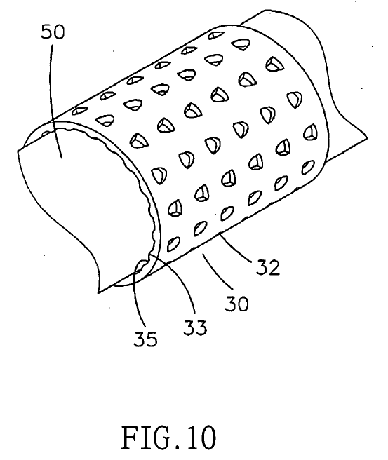

As shown in FIGS. 9 and 10, the cushion body 30 has an end face formed with a plurality of arc-shaped protruding stripes 33 and a plurality of channels 35 between the protruding stripes 33. Thus, the channels 35 are located between the protruding stripes 33 and the user's one elbow 50, thereby enhancing the ventilating effect of the gas permeable cushion.

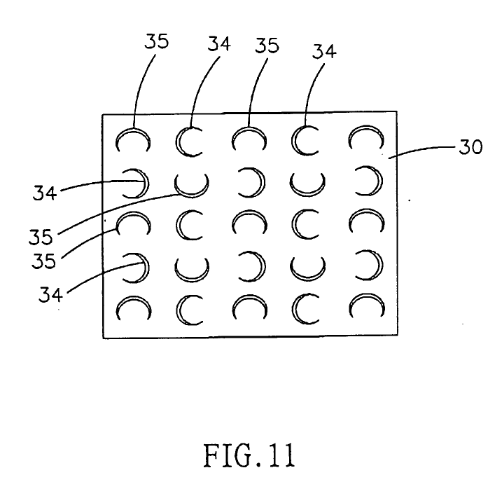

Referring to FIGS. 11-13, the cushion body 30 has a plurality of arc-shaped holes 34 and 35 having different axial directions. In addition, the arc-shaped holes 34 and 35 are arranged in a staggered manner.

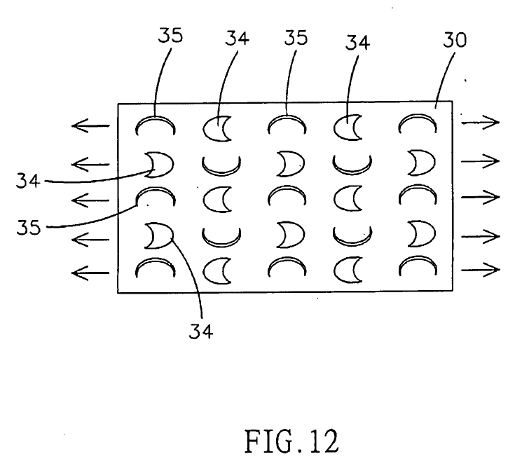

As shown in FIG. 12, when the cushion body 30 is extended transversely, the transversely directed arc-shaped holes 34 are expanded and the longitudinally directed arc-shaped holes 35 are maintained at the original state.

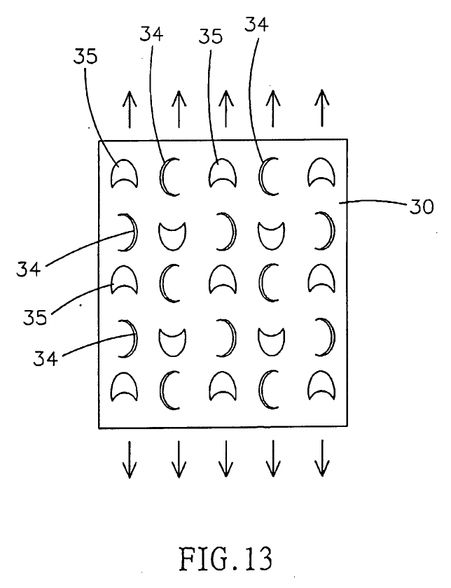

As shown in FIG. 13, when the cushion body 30 is extended longitudinally, the longitudinally directed arc-shaped holes 35 are expanded and the transversely directed arc-shaped holes 34 are maintained at the original state.

Accordingly, the method of the present invention is used for working a gas permeable cushion without needing a step of removing the wasted material, thereby simplifying the procedure of the method, so that the gas permeable cushion is worked easily and conveniently. In addition, the gas permeable cushion has a plurality of arc-shaped holes, thereby enhancing the ventilating effect of the gas permeable cushion. Further, the arc-shaped holes 32 are expanded and contracted according to the usage state of the user's body, thereby enhancing the ventilating effect of the gas permeable cushion. Further, the channels 35 are located between the protruding stripes 33 and the user's one elbow 50, thereby enhancing the ventilating effect of the gas permeable cushion.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A method for working a gas permeable cushion, comprising:
taking a cushion body;
stamping a plurality of arc-shaped sections on the cushion body;
extending the cushion body to expand the arc-shaped sections, thereby forming a plurality of arc-shaped holes; and
bonding two cloth layers onto top and bottom faces of the cushion body respectively, thereby forming a gas permeable cushion which has a plurality of arc-shaped holes.

2. The method in accordance with claim 1, wherein the cushion body is made of foamable material.

3. The method in accordance with claim 1, wherein the cushion body is formed by EVA.

4. The method in accordance with claim 1, wherein the cushion body is formed by PE.

5. The method in accordance with claim 1, wherein the arc-shaped sections of the cushion body have the same axial direction.

6. The method in accordance with claim 5, wherein the cushion body is extended along the axial direction of the arc-shaped sections.

7. The method in accordance with claim 1, wherein the arc-shaped holes are expanded and contracted according to a state of a user's body.

8. The method in accordance with claim 1, wherein the cushion body has an end face formed with a plurality of arc-shaped protruding stripes and a plurality of channels located between the protruding stripes.

9. The method in accordance with claim 1, wherein the arc-shaped holes of the cushion body have the same axial directions.

10. The method in accordance with claim 1, wherein the arc-shaped holes of the cushion body have different axial directions.

11. The method in accordance with claim 1, wherein the arc-shaped holes of the cushion body are arranged in a staggered manner.

12. The method in accordance with claim 1, wherein when the cushion body is extended transversely, the cushion body has transversely directed arc-shaped holes which are expanded and has longitudinally directed arc-shaped holes which are maintained at an original state.

13. The method in accordance with claim 1, wherein when the cushion body is extended longitudinally, the cushion body has longitudinally directed arc-shaped holes which are expanded and have transversely directed arc-shaped holes which are maintained at an original state.
